(19) United States
(12) Patent Application Publication
(10) Pub. No.: US 2026/0008399 A1
(43) Pub. Date: Jan. 8, 2026

(54) VEHICULAR DOOR TRIM

(71) Applicants: TOYOTA BOSHOKU KABUSHIKI KAISHA, Aichi-ken (JP); TOYOTA JIDOSHA KABUSHIKI KAISHA, Aichi-ken (JP); KABUSHIKI KAISHA TOYOTA JIDOSHOKKI, Aichi-ken (JP)

(72) Inventors: Susumu HOJO, Aichi-ken (JP); Takanori ISAKA, Mie-ken (JP); Kihiro KATO, Aichi-ken (JP); Hirokazu NIIMI, Aichi-ken (JP)

(73) Assignees: TOYOTA BOSHOKU KABUSHIKI KAISHA, Aichi-ken (JP); TOYOTA JIDOSHA KABUSHIKI KAISHA, Aichi-ken (JP); KABUSHIKI KAISHA TOYOTA JIDOSHOKKI, Aichi-ken (JP)

(21) Appl. No.: 19/248,964

(22) Filed: Jun. 25, 2025

(30) Foreign Application Priority Data
Jul. 3, 2024 (JP) 2024-107286

(51) Int. Cl. B60N 3/02; B60R 13/02

(52) U.S. Cl. CPC B60N 3/02; B60R 13/0243

(57) ABSTRACT

A vehicular door trim includes a trim board and a pull handle that includes an inner member, an outer member, and an overlapping portion. The inner member includes an inner extending portion as a peripheral edge portion. The outer member includes an outer extending portion as a peripheral edge portion. The outer member and the inner member are fitted together and define a recess portion and having a connection portion therebetween. The overlapping portion includes the inner and outer extending portions that are overlapped and includes a first overlapping portion fixed to the trim board with a fixing portion in a fixing direction and a second overlapping portion adjacent to the connection portion and extending in a direction crossing a plate surface of the trim board. The second overlapping portion includes a stopper hole and a stopper projection that are fitted by relative movement along the fixing direction.

### CROSS REFERENCE TO RELATED APPLICATION

This application claims priority from Japanese Patent Application No. 2024-107286 filed on Jul. 3, 2024. The entire contents of the priority application are incorporated herein by reference.

### TECHNICAL FIELD

The present disclosure relates to a vehicular door trim.

### BACKGROUND

There has been known a vehicular door trim that includes a pull handle. The pull handle (a pull handle box) has a box shape that opens upward and a vehicle occupant puts his or her fingers in a recess portion of the pull handle to open and close the vehicular door.

A pull handle may include multiple members that are fitted together. When such a pull handle is produced with injection molding, each of the members is separately molded and the members are joined together. Thus, a pull handle having a complicated shape can be produced according to various designs. However, with the pull handle being produced by joining the multiple members, rigidity is likely to be lowered compared to a pull handle integrally molded.

### SUMMARY

With the members of the pull handle being separated in a vehicular interior-exterior direction, a connection portion or a border of the members receives a large load when the pull handle is held and the vehicular door is closed. Then, one or both of the members may be deformed. If such deformation occurs, a gap may be created at the connection portion between the members and the design may be degraded.

When the pull handle is fixed to the door trim with bolts and nuts or thermal caulking, the pull handle is fixed to the door trim vertically with respect to a plate surface of the door trim and the fixing direction, which is a vertical direction to the plate surface of the door trim, is determined. Therefore, if the fixing portion may be necessarily far away from the connection portion, a gap is more likely to be caused at the connection portion between the members of the pull handle.

An object of the present technology is to provide a vehicular door trim including a pull handle that has a divided structure and increased rigidity.

A vehicular door trim according to the technology described herein includes a trim board configured as a vehicular interior surface of a vehicular door and a pull handle mounted on the trim board. The pull handle includes a recess portion having an opening that opens upward, an inner member, an outer member, and an overlapping portion. The inner member includes an inner body portion and an inner extending portion that extends outside the recess portion from the inner body portion and is configured as a portion of a peripheral edge portion of the inner member. The inner body portion includes an inner wall that is configured as a vehicular interior side wall of the recess portion. The outer member includes an outer body portion and an outer extending portion that extends outside the recess portion from the outer body portion and is configured as a portion of a peripheral edge portion of the outer member. The outer body portion includes an outer wall that is configured as a vehicular exterior side wall of the recess portion. The outer member and the inner member are fitted together and configured as the pull handle and define the recess portion and have a connection portion between the inner member and the outer member. The overlapping portion includes the inner extending portion and the outer extending portion that are overlapped. The overlapping portion includes a first overlapping portion that overlaps the trim board and is fixed to the trim board with a fixing portion in a fixing direction, and a second overlapping portion that is adjacent to the connection portion and extends in a direction crossing a plate surface of the trim board. The second overlapping portion includes a stopper portion. The stopper portion includes a stopper hole included in one of the inner member and the outer member and a stopper projection included in another one of the inner member and the outer member. The stopper projection and the stopper hole are fitted to each other by relative movement of the stopper projection and the stopper hole along the fixing direction.

### BRIEF DESCRIPTION OF THE DRAWINGS

FIG. 1 is a perspective view of a door trim according to one embodiment.

FIG. 2 is an exploded perspective view of the door trim seen from a vehicular exterior side.

FIG. 3 is a perspective view of a pull handle that is fixed to a lower trim seen from the vehicular exterior side.

FIG. 4 is a perspective view of the pull handle and an armrest body member that are fixed to the lower trim seen from the vehicular exterior side.

FIG. 5 is a perspective view of the pull handle.

FIG. 6 is an exploded perspective view of the pull handle.

FIG. 7 is an elevation view of an inner member seen from the vehicular exterior side.

FIG. 8 is an elevation view of an outer member seen from the vehicular exterior side.

FIG. 9 is an enlarged perspective view of a stopper portion before being fitted together.

FIG. 10 is an enlarged perspective view of the stopper portion after being fitted together.

FIG. 11 is a cross-sectional view of the stopper portion before being fitted.

FIG. 12 is a cross-sectional view of the stopper portion during being fitted together.

FIG. 13 is a cross-sectional view of the stopper portion after being fitted together.

### DETAILED DESCRIPTION

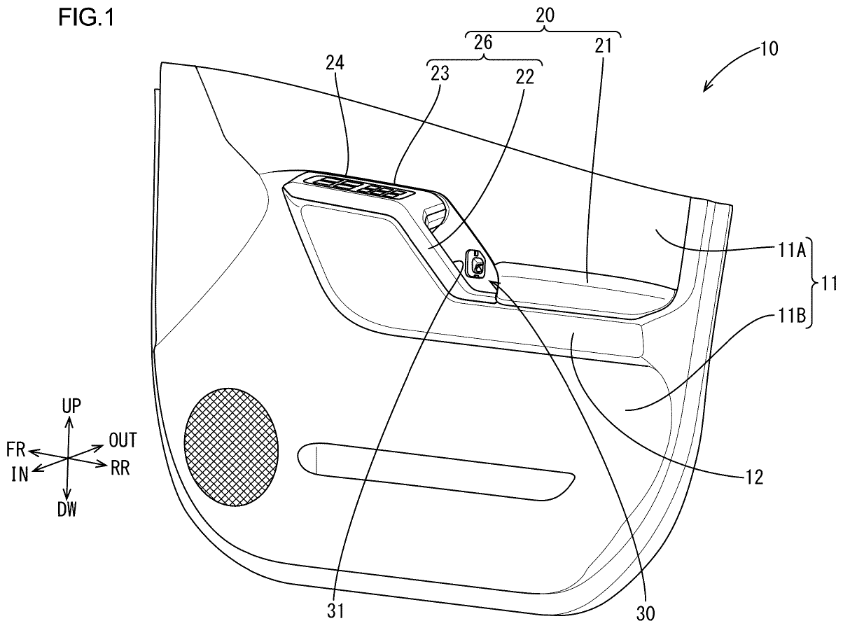

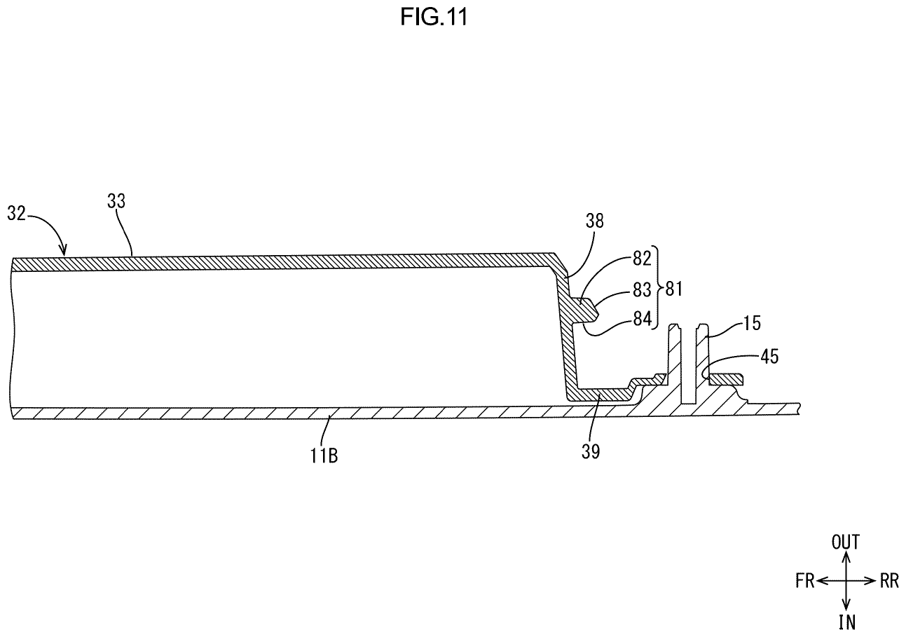

One embodiment of the present technology will be described with reference to FIGS. 1 to 13. In each of the drawings, arrows FR and RR represent a vehicular front side (a vehicular forward moving direction) and a vehicular rear side, respectively, arrows IN and OUT represent a vehicular interior side and a vehicular exterior side, respectively, and arrows UP and DW represent an upper side and a bottom side, respectively. The arrows represent directions with a pull handle 30 being mounted on a trim board 11 of a vehicular door trim 10.

As illustrated in FIG. 1, the door trim 10 includes the trim board 11 of a plate shape as a main portion. The trim board 11 includes an upper trim 11A and a lower trim 11B. The lower trim 11B includes plate members that are joined together. Functional components are fixed to the plate members or the plate members are connected together and configured as a functional component. The upper trim 11A and the lower trim 11B are made of synthetic resin material having electrically insulating properties such as polypropylene and may be covered with a skin that improves surface quality and texture as necessary.

An armrest 20 is disposed between an upper edge of the lower trim 11B and a lower edge of the upper trim 11A. The armrest 20 is on the vehicular exterior side of the upper edge of the lower trim 11B. The armrest 20 extends along a vehicular front-rear direction and projects toward the vehicular interior side. The upper trim 11A includes a projection portion 12 that projects from an upper section of the lower trim 11B toward the vehicular interior side. The armrest 20 is between an upper edge of the projection portion 12 and the lower edge of the upper trim 11A. The armrest 20 includes an armrest surface portion 21, a slope surface portion 22, and a flat surface portion 23. The armrest surface portion 21 is a vehicular rear section of the armrest 20 and horizontally extends. The slope surface portion 22 is on a front side of and continuous from the armrest surface portion 21 and is sloped upward as it extends frontward. The flat surface portion 23 is on a front side of and continuous from the slope surface portion 22 and horizontally extends.

The armrest surface portion 21 is included in an armrest body member 25 having a plate surface that horizontally extends. A surface (an upper surface, a vehicular interior side surface) of the armrest surface portion 21 is covered by a skin having cushioning. The slope surface portion 22 and the flat surface portion 23 are included in an armrest front portion 26. A switch base 24 including switches for various kinds of operations is on the flat surface portion 23. The slope surface portion 22, which is between the armrest surface portion 21 and the switch base 24, includes a pull handle 30 that opens toward a rear upper direction such that a passenger puts his or her hand in the pull handle 30 when opening and closing the vehicular door from the vehicular interior side.

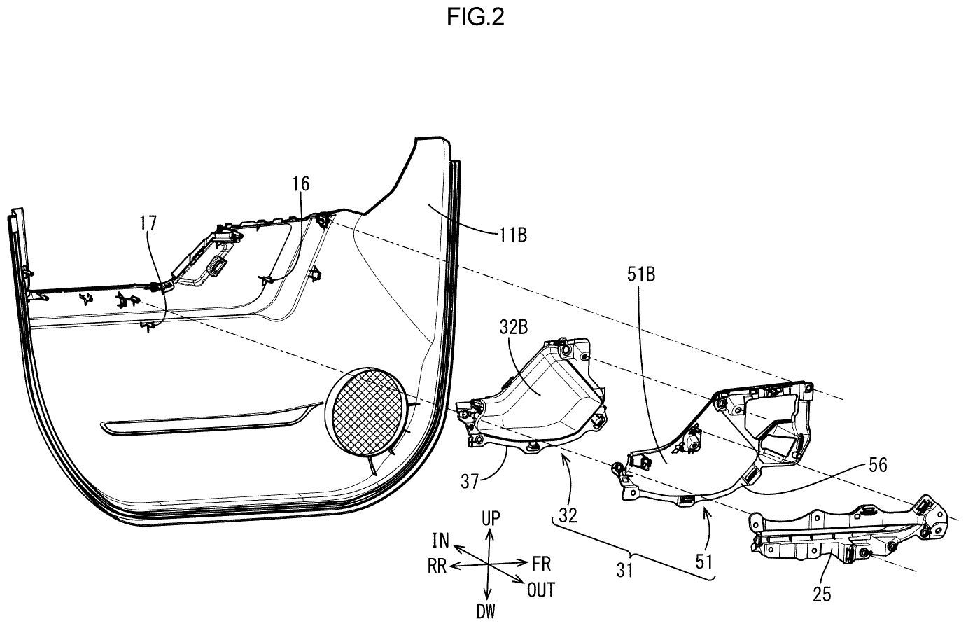

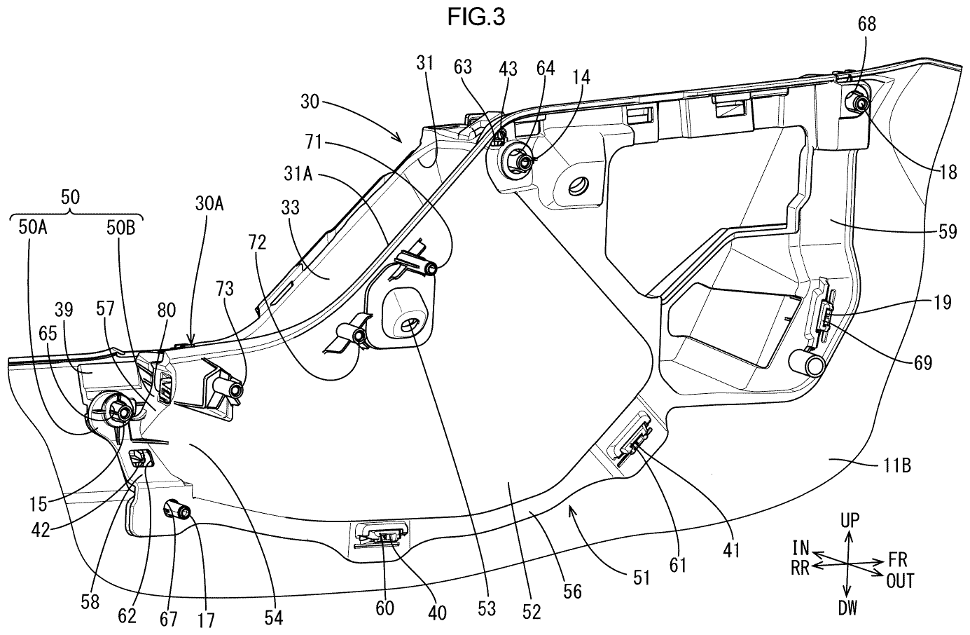

The pull handle 30 is made of synthetic resin, for instance, thermoplastic resin such as polypropylene and polyethylene. The pull handle 30 includes a recess portion 31 that is recessed from the slope surface portion 22. A passenger's hand can be inserted in the recess portion 31. The recess portion 31 has a box shape opening toward an upper rear direction. As illustrated in FIGS. 2, 3 and 5, the recess portion 31 is configured by joining an inner member 32 that is on the vehicular interior side and an outer member 51 that is on the vehicular exterior side with respect to the inner member 32. The inner member 32 and the outer member 51 are joined together to form the recess portion 31. As illustrated in FIG. 3, upper edges of the inner member 32 and the outer member 51 are configured as an opening edge 31A of an opening of the recess portion 31.

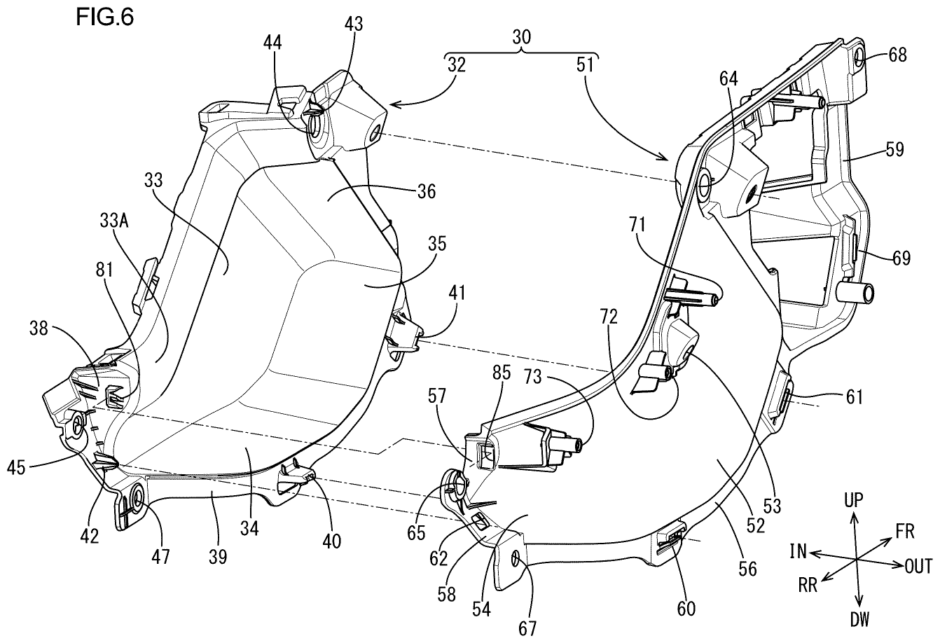

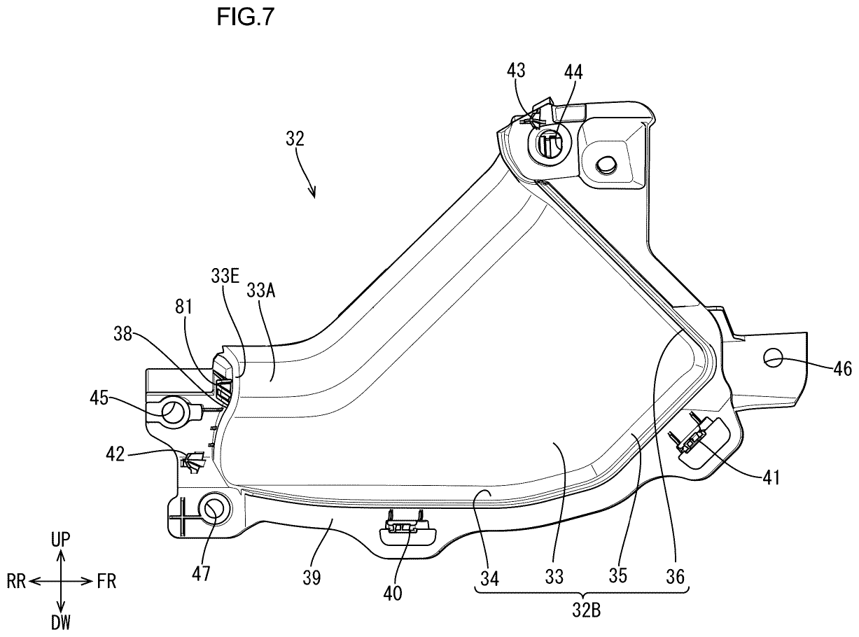

As illustrated in FIGS. 6 and 7, the inner member 32 is a bent plate member that is bent to be recessed toward the vehicular interior side. The inner member 32 is on the vehicular exterior side of the lower trim 11B (the projection portion 12) and opens toward the vehicular exterior side. As illustrated in FIG. 2, the inner member 32 includes an inner body portion 32B and an inner extending portion 37 that extends outward from the inner body portion 32B. As illustrated in FIG. 7, the inner body portion 32B includes an inner wall 33, a bottom wall 34, a lower front wall 35, and an upper front wall 36. The inner wall 33 is configured as the vehicular interior side surface of the recess portion 31 of the pull handle 30. The inner wall 33 extends along a plate surface of the lower trim 11B. The bottom wall 34 extends from a lower edge of the inner wall 33 in a horizonal direction toward the vehicular exterior side. The bottom wall 34 is configured as a bottom surface of the recess portion 31. The lower front wall 35 extends from a vehicular front edge of the bottom wall 34 in an upper front direction and is inclined with respect to the bottom wall 34. The upper front wall 36 extends from an upper edge of the lower front wall 35 in an upper rear direction and is inclined with respect to the vertical direction. The bottom wall 34 has a trapezoidal shape having two sides extending along the plate surface of the trim board 11. The bottom wall 34 is tapered toward the vehicular rear side such that a rear edge of the bottom wall 34 extends closer toward the vehicular interior side as it extends rearward. The upper front wall 36 extends vertically with respect to the slope surface portion 22 of the armrest 20.

The inner wall 33 includes a projection portion 33A at an upper edge of the inner wall 33. The projection portion 33A extends along the opening edge 31A of the recess portion 31. The projection portion 33A projects toward the vehicular exterior side (inward of the recess portion 31). With the projection portion 33A, the passenger can hold the projection portion 33A from a lower side when inserting his or her finger into the recess portion. Thus, the passenger can easily hold the upper portion of the pull handle 30.

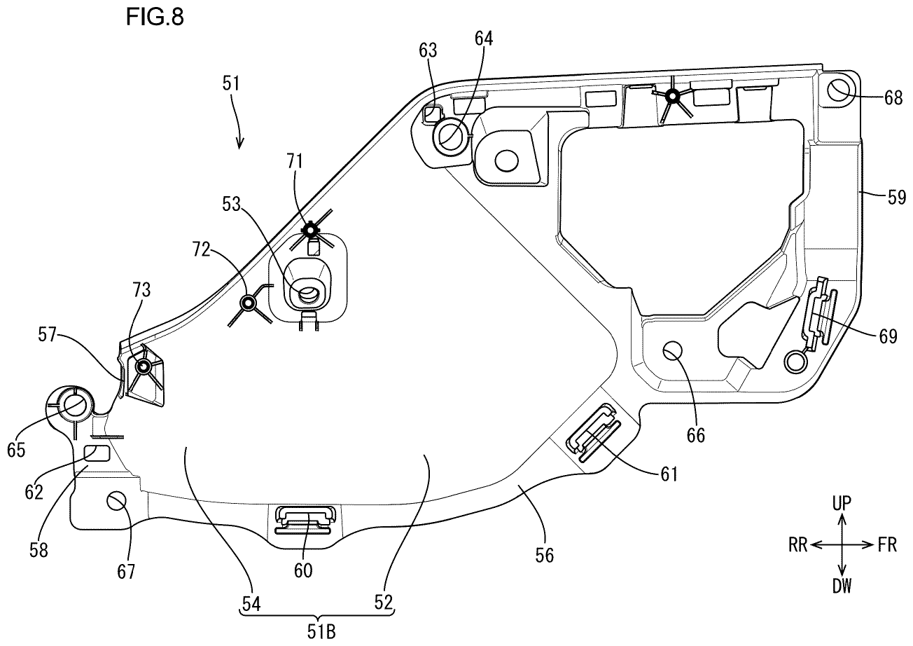

As illustrated in FIGS. 6 and 8, the outer member 51 is a plate member that is bent so as to close the inner space surrounded by the inner body portion 32B of the inner member from the vehicular exterior side and thus, the recess portion 31 is formed by the inner member 32 and the outer member 51. The outer member 51 includes an outer body portion 51B and an outer extending portion 56 extending outward from the outer body portion 51B. The outer body portion 51B includes an outer wall 52 and a rear wall 54. The outer wall 52 is disposed opposite the inner wall 33 of the inner member 32. The rear wall 54 extends from a rear edge of the outer wall 52 toward the rear and vehicular interior side. Namely, the inner space of the recess portion 31 is defined by the inner wall 33, the bottom wall 34, the lower front wall 35, and the upper front wall 36 of the inner member 32 and the outer wall 52 and the rear wall 54 of the outer member 51. The inner wall 33, the bottom wall 34, the lower front wall 35, and the upper front wall 36 of the inner member 32 and the outer wall 52 and the rear wall 54 of the outer member 51 define the recess portion 31.

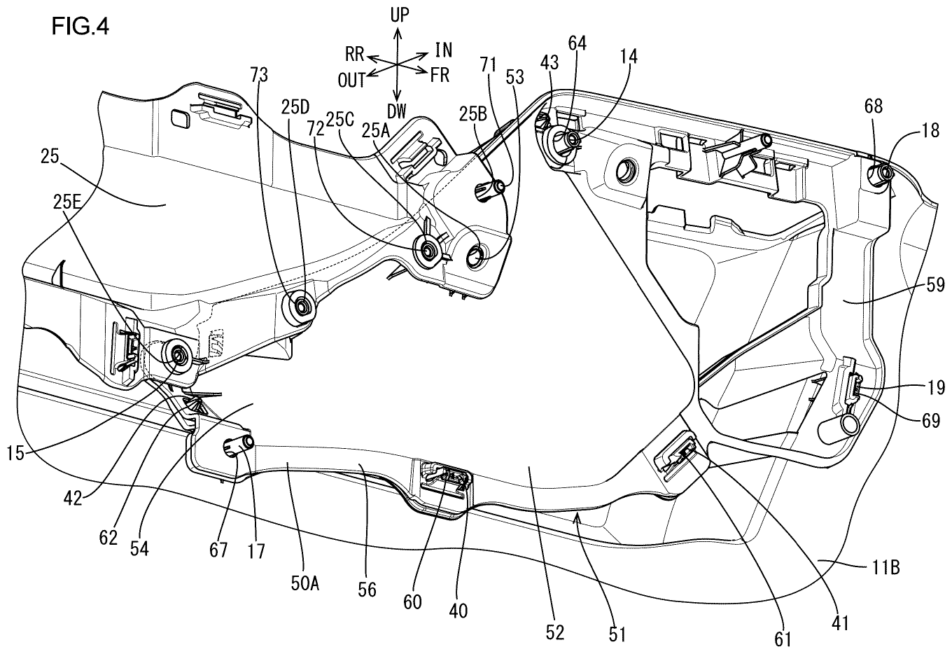

The outer wall 52 includes a panel fixing hole 53 in a middle of an upper edge portion. A bolt is inserted through the panel fixing hole 53 for fixing the outer member 51 and the armrest body member 25 to a door panel. FIG. 4 is a perspective view illustrating the pull handle 30 and the armrest body member 25 that are mounted on the lower trim 11B with the panel fixing hole 53 overlapping a panel fixing hole 25A of the armrest body member 25. As illustrated in FIGS. 4 and 8, the outer member 51 includes mounting bosses 71, 72, 73 on the vehicular exterior side surface. The mounting bosses 71, 72 73 are for fixing the armrest body member 25. The armrest body member 25 includes bolt insertion holes 25B, 25C, 25D in portions corresponding to the mounting bosses 71, 72, 73. The armrest body member 25 includes a boss insertion hole 25E through which a mounting boss 15 projecting from the lower trim 11B is inserted. The armrest body member 25 is integrally attached to the pull handle 30. The armrest body member 25 is on the rear side of the pull handle 30.

As illustrated in FIGS. 6 and 7, the inner member 32 includes the inner extending portion 37 at a peripheral edge portion. The inner extending portion 37 extends outside the recess portion 31. The inner member 32 has no inner extending portion 37 at the opening edge 31A of the recess portion 31. The inner extending portion 37 is provided on a portion of the peripheral edge portion except for the portion including the opening edge 31A of the recess portion 31. The inner extending portion 37 includes an inner end wall 38 and a flange portion 39. More specifically, as illustrated in FIG. 6, the inner member 32 includes the inner end wall 38 (one example of an inner extending portion, one example of a portion of a second overlapping portion) at a rear end of the projection portion 33A. The projection portion 33 A has a curved shape projecting toward the vehicular exterior side and has a curved end portion 33E at the rear end. The inner end wall 38 extends to close an opening defined by the curved end portion 33E. The inner end wall 38 extends from the curved end portion 33E toward the vehicular interior side. The inner end wall 38 extends in a direction crossing the plate surface of the lower trim 11B. The inner end wall 38 extends along a vehicular interior-exterior direction. The inner end wall 38 extends vertically with respect to the plate surface of the lower trim 11B from the rear end of the projection portion 33A. Or the inner end wall 38 may extend from the rear end of the projection portion 33A so as to be inclined from the vertical position with respect to the surface of the lower trim 11B. With the inner member 32 being fixed to the trim board 11, the inner end wall 38 closes a space between the rear end of the projection portion 33A and the trim board 11.

The inner member 32 includes the flange portion 39 (one example of the inner extending portion, one example of a portion of a first overlapping portion) at the peripheral edge portion. The flange portion 39 extends toward the outside the recess portion 31 and extends along the plate surface of the lower trim 11B. The flange portion 39 extends outward from the inner body portion 32B. In the portion of the peripheral edge portion of the inner member 32 including the inner end wall 38, the flange portion 39 extends toward the outside of the recess portion 31 from a vehicular interior side edge of the inner end wall 38. Namely, the flange portion 39 is integrally continuous from the edge of the inner end wall 38.

On the other hand, as illustrated in FIGS. 6 and 8, the outer member 51 includes the outer extending portion 56 at a peripheral edge portion. The outer extending portion 56 extends outside the recess portion 31. The outer member 51 has no outer extending portion 56 at the opening edge 31A of the recess portion 31. The outer extending portion 56 is provided on a portion of the peripheral edge portion except for the portion including the opening edge 31A of the recess portion 31. Most portion of the outer extending portion 56 extends along the plate surface of the outer member 51. Specifically, the outer extending portion 56 includes an outer end wall 57 (one example of an outer extending portion, one example of a portion of the second overlapping portion) that extends from a rear end of the rear wall 54. A portion of the outer extending portion 56 except for the outer end wall 57 extends in a direction along the plate surface of the outer member 51.

The outer end wall 57 is opposed to the inner end wall 38 when the outer member 51 and the inner member 32 are joined together. The outer end wall 57 overlaps the inner end wall 38 from the vehicular exterior side when the outer member 51 and the inner member 32 are joined together. Namely, the outer end wall 57 extends in a direction crossing the plate surface of the lower trim 11B. The outer end wall 57 extends along the vehicular interior-exterior direction.

The outer extending portion 56 includes a portion that extends from the rear end of the rear wall 54 and is different from the portion where the outer end wall 57 extends. Such a portion extends along the plate surface of the lower trim 11B in a flange form. The portion of the outer extending portion 56 extending substantially along the plate surface of the lower trim 11B is defined as an outer rear end extending portion 58 (one example of the outer extending portion, one example of a portion of the first overlapping portion). The outer rear extending portion 58 overlaps a portion of the flange portion 39 of the inner member 32 (a portion extending from the inner wall 33). The outer rear extending portion 58 is not continuous from the vehicular interior edge of the outer end wall 57. Namely, the vehicular interior edge of the outer end wall 57 is configured as a portion of the peripheral edge portion of the outer member 51.

As illustrated in FIGS. 6 and 8, the outer extending portion 56 includes an extending frame portion 59 that extends frontward and is on the front side of the outer wall 52. An upper portion of the extending frame portion 59 is a portion of a mount portion where the switch base 24 (the armrest front portion 26) is attached. The upper portion of the extending frame portion 59, the lower trim 11B, and the upper front wall 36 of the inner member 32 are configured as the mount portion.

With the inner member 32 and the outer member 51 being in a correct position with respect to the trim board 11, the recess portion 31 of the pull handle 30 is defined by the inner member 32 and the outer member 51. As illustrated in FIG. 3, a portion of the inner extending portion 37 and a portion of the outer extending portion 56 that are overlapped are configured as an overlapping portion 50.

As illustrated in FIGS. 6 to 8, the flange portion 39 of the inner extending portion 37 includes stopper projections 40, 41 on portions extending from the bottom wall 34 and the lower front wall 35, respectively. The stopper projections 40, 41 project from the flange portion 39 toward the vehicular exterior side. The outer extending portion 56 includes stopper holes 60, 61 in portions thereof opposed to the stopper projections 40, 41, respectively. The stopper projections 40, 41 are fitted to the stopper holed 60, 61, respectively. The flange portion 39 of the inner extending portion 37 includes positioning projections 42, 43 on a portion that is continuous rearward from the inner wall 33 and a portion that is continuous from the upper front wall 36 toward the vehicular exterior side, respectively. The positioning projections 42, 43 project from the flange portion 39 toward the vehicular exterior side. The outer extending portion 56 includes positioning holes 62, 63 in portions thereof opposed to the positioning projections 42, 43, respectively. The positioning projections 42, 43 are fitted in the positioning holes 62, 63, respectively. By the fitting of the stopper projections 40, 41 to the stopper holes 60, 61 and the positioning with the positioning projections 42, 43 and the positioning holes 62, 63, the outer member 51 is attached to the inner member 32 with a correct posture and integrally held by the inner member 32. The direction in which the stopper projections 40, 41 are fitted in the respective stopper holes 60, 61 and the direction in which the positioning projections 42, 43 are inserted in the respective positioning holes 62, 63 correspond to the direction along the vehicular interior-exterior direction (the vehicular width direction). The stopper projections 40, 41 and the positioning projections 42, 43 extend in the vehicular interior-exterior direction.

As illustrated in FIG. 6, the inner extending portion 37 includes boss insertion holes 44, 45 in front and rear portions of the upper edge portion, respectively. Namely, the boss insertion hole 44 is near the opening edge 31A of the recess portion 31 and the boss insertion hole 45 is in a first overlapping portion 50A. The outer extending portion 56 includes boss insertion holes 64, 65 in front and rear portions of the upper edge portion, respectively. Namely, as illustrated in FIG. 3, the boss insertion hole 64 is near the opening edge 31A of the recess portion 31 and the boss insertion hole 65 is in the first overlapping portion 50A. A mounting boss 14 that projects from the lower trim 11B toward the vehicular exterior side is inserted through the boss insertion holes 44, 64 and a mounting boss 15 that projects from the lower trim 11B toward the vehicular exterior side is inserted through the boss insertion holes 45, 65. The inner extending portion 37 includes boss insertion holes 46, 47 in front and rear portions of the lower edge portion, respectively. The outer extending portion 56 includes boss insertion holes 66, 67 in front and rear portions of the lower edge portion, respectively. A mounting boss 16 (refer to FIG. 2) that projects from the lower trim 11B toward the vehicular exterior side is inserted through the insertion holes 46, 66 and a mounting boss 17 (refer to FIGS. 2 and 3) that projects from the lower trim 11B toward the vehicular exterior side is inserted through the boss insertion holes 47, 67. Furthermore, the extending frame portion 59 includes a boss insertion hole 68 in a front upper edge portion thereof and a stopper hole 69 in a front lower edge portion thereof. As illustrated in FIG. 3, a mounting boss 18 that projects from the lower trim 11B toward the vehicular exterior side is inserted through the boss insertion hole 68. A stopper projection 19 that projects from the lower trim 11B toward the vehicular exterior side is inserted through the stopper hole 69. The mounting bosses 14, 15, 16, 17, 18 and the stopper projection 19 extend in the vehicular interior-exterior direction.

By the fixing with the mounting bosses 14, 15, 16, 17, 18 (fixing portion) and the fitting of the stopper projection 19, the inner member 32 and the outer member 51 are fixed to the lower trim 11B in a correct posture and integrally held by the lower trim 11B. The direction in which the mounting boss 14, 15, 16, 17, 18 is inserted through the boss insertion hole 44, 45, 46, 47, 64, 65, 66, 67, 68, that is, the fixing direction of the mounting boss 14, 15, 16, 17, 18, and the direction in which the stopper projection 19 is fitted in the stopper hole 69 correspond to the direction along the vehicular interior-exterior direction (the vehicular width direction).

In this embodiment, “fixing” means connecting three or two components by inserting the mounting boss 14, 15, 16, 17, 18 through the boss insertion hole 44, 45, 46, 47, 64, 65, 66, 67, 68 and fixing the inner member 32 and the outer member 51 to the lower trim 11B. As one example of a method of fixing, a bolt or a nut may be fixed to the mounting boss 14, 15, 16, 17, 18 or the mounting boss 14, 15, 16, 17, 18 may be fixed with thermal caulking. With such a method, the fixing portion may be obtained.

With the pull handle 30 (the recess portion 31) being formed by joining the inner member 32 and the outer member 51, the rigidity may be lowered compared to an integrally formed pull handle. Specifically, when a vehicle occupant operates the pull handle, a load (applied along the vehicular interior-exterior direction) is likely to be applied to a connection portion 30A (a border) of the inner member 32 and the outer member 51 and one or both of the inner member 32 and the outer member 51 may be deformed. Particularly, when a force is applied toward the vehicular interior side, a gap may be caused at the connection portion and this may lower the interior design. Such a gap is likely to be caused in a rear section of the opening edge of the recess portion where a large force is likely to be applied when closing the door. The direction in which the inner member and the outer member are collectively fixed to the lower trim with the fixing portion (the mounting boss 14, 15, 16, 17, 18) is limited to the vehicular interior-exterior direction. Therefore, the fixing portion may be necessarily in a portion far away from the connection portion 30A. In such a configuration, a gap is more likely to be caused between the inner member 32 and the outer member 51.

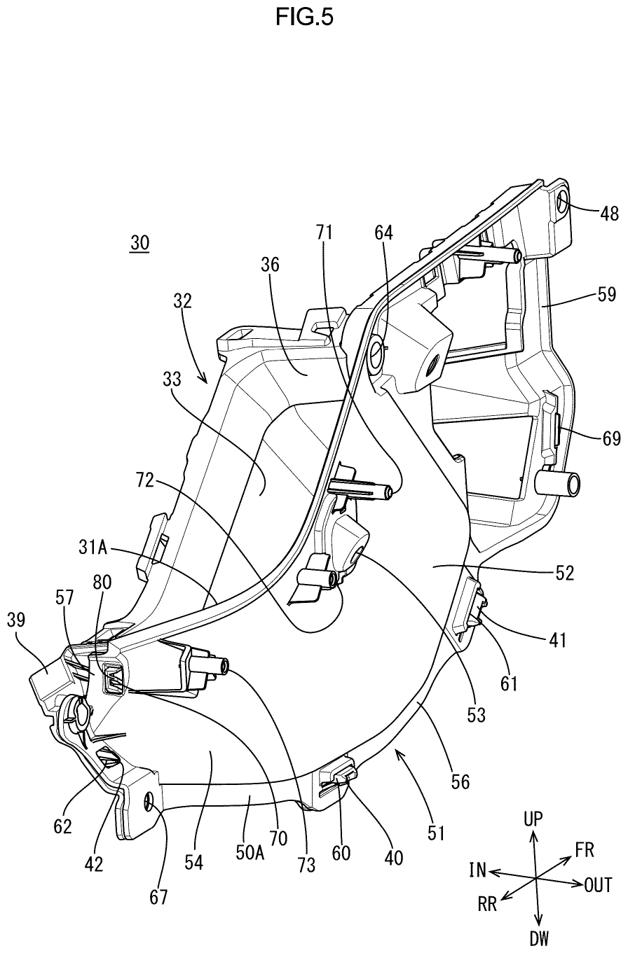

As illustrated in FIGS. 3 and 5, this embodiment includes a stopper portion 80 with which the inner member 32 and the outer member 51 are connected to each other and that restricts movement of the inner member 32 and the outer member 51 in the vehicular interior-exterior direction. The stopper portion 80 is on a rear portion of the connection portion 30A that is on a rear side of the opening of the recess portion 31 where a large force is likely to be applied and closer to the recess portion 31 than the fixing portion (the mounting boss 15) is. Namely, the stopper portion 80 is adjacent to the rear portion of the connection portion 30A that is on the rear side of the opening of the recess portion 31 and is in a second overlapping portion 50B where the inner end wall 38 and the outer end wall 57 overlap in a direction along the plate surface of the lower trim 11B. The stopper portion 80 includes a stopper projection 81 and a stopper hole 85. The stopper projection 81 projects from the vehicular exterior side surface (a rear surface) of the inner end wall 38 toward the vehicular rear side. The stopper projection 81 projects along the front-rear direction. The stopper hole 85 is in a portion of the outer end wall 57 opposite the stopper projection 81 when the outer member 51 is attached to the inner member 32. The stopper projection 81 is fitted in the stopper hole 85 and the stopper hole 85 holds the stopper projection 81 with the outer member 51 being attached to the inner member 32.

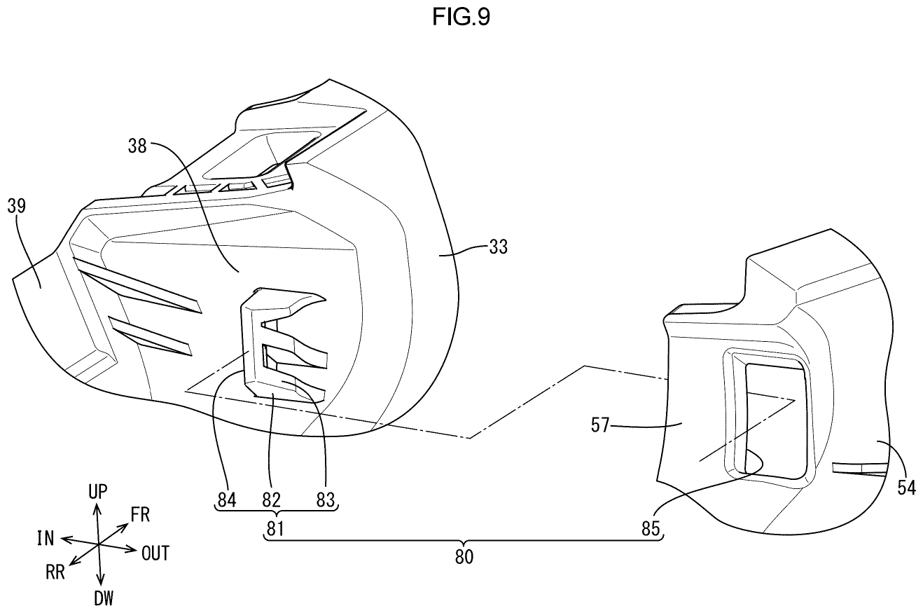

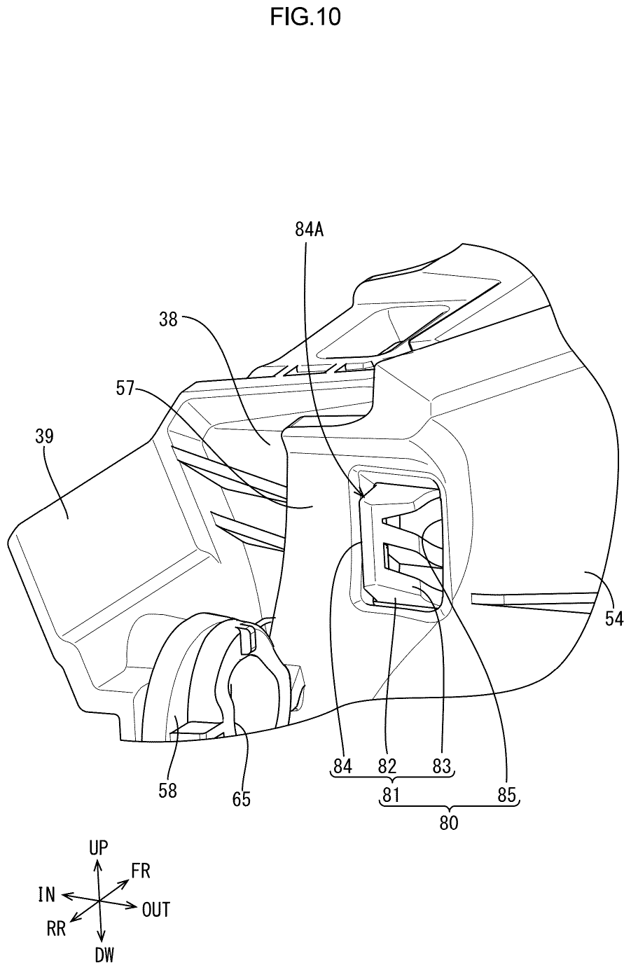

As illustrated in FIGS. 9 and 10, the stopper projection 81 includes three ribs 82 each having a plate shape and a base 84 that connect the three ribs 82. The ribs 82 project from the vehicular rear side surface of the inner end wall 38. The ribs 82 are arranged in the upper-bottom direction with plate surfaces facing the upper and lower sides. The ribs 82 have guide surfaces 83 on the vehicular exterior side edge surfaces. The guide surfaces 83 are upward slopes that are inclined upward as they extend from the vehicular exterior side toward the vehicular interior side. Vehicular interior side edge surfaces of the ribs 82 are connected by the base 84. The base 84 is a plate member extending in the upper-bottom direction. A vehicular interior side surface of the base 84 is defined as a stopper surface 84A. The stopper surface 84A extends substantially vertically from the inner end wall 38.

The stopper hole 85 is a rectangular hole and in a portion of the outer end wall 57 corresponding to the stopper projection 81 when the outer end wall 57 overlaps the inner end wall 38. With the outer end wall 57 overlapping the inner end wall 38, the stopper projection 81 is fitted in the stopper hole 85.

As illustrated in FIG. 3, the stopper portion 80 including the stopper projection 81 and the stopper hole 85 and the fixing portion, which corresponds to the mounting boss 15 and the boss insertion holes 45, 65, are arranged adjacent to each other in the vehicular front-rear direction and on the rear side of the opening of the recess portion 31.

The pull handle 30 of this embodiment having the above configuration is obtained as follows by fitting the inner member 32 and the outer member 51 in the vehicular interior-exterior direction, which crosses the plate surface of the lower trim 11B. First, the mounting bosses 14, 15, 16, 17 of the lower trim 11B are inserted through the boss insertion holes 44, 45, 46, 47 of the inner member 32, respectively, so as to position the inner member 32 with respect to the lower trim 11B. Next, the mounting bosses 14, 15, 16, 17, 18 of the lower trim 11B are inserted through the boss insertion holes 64, 65, 66, 67, 68 of the outer member 51, respectively. Furthermore, as illustrated in FIG. 3, the positioning projections 42, 43 of the inner member are inserted in the positioning holes 62, 63 of the outer member 51, respectively. Thus, the outer extending portion 56 is moved closer to and overlapped with the inner extending portion 37 with the outer member 51 being positioned with respect to the inner member 32 and the lower trim 11B. Accordingly, the stopper projections 40, 41 of the inner member 32 and the stopper projection 19 of the lower trim 11B are fitted in the respective stopper holes 60, 61, 69 of the outer member 51, respectively, and stopped by and contacted with the hole edges of the holes 60, 61, 69.

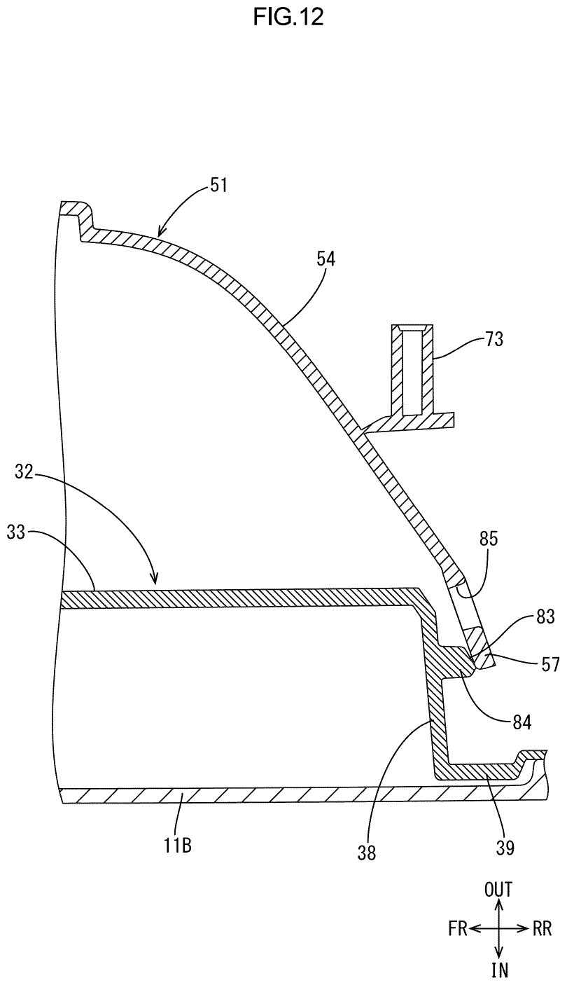

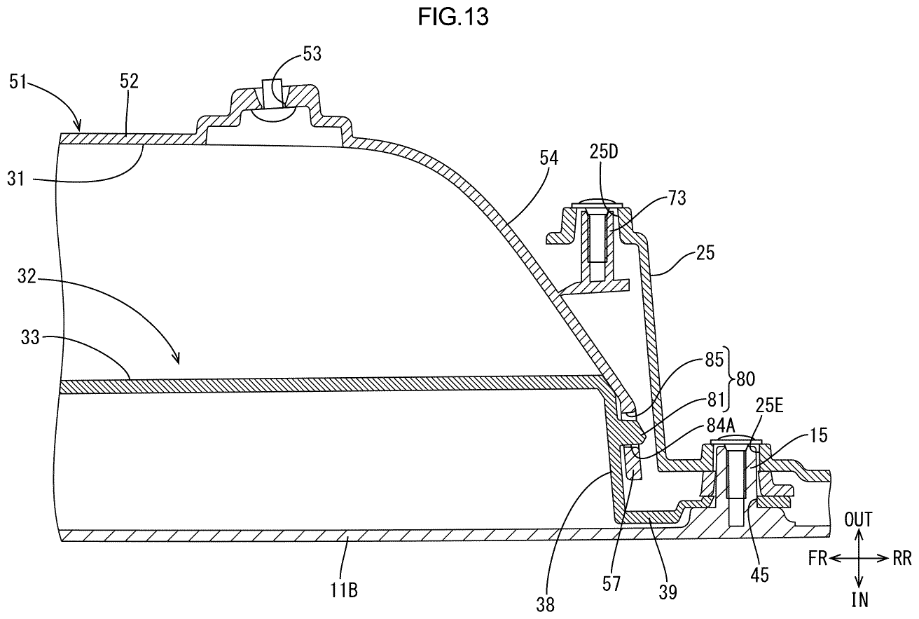

With the stopper projections 40, 41, 19 being fitted in the stopper holes 60, 61, 69, respectively, the vehicular interior side edge portion of the outer end wall 57 of the outer member 51 comes in contact with the stopper projection 81 of the inner end wall 38 of the inner member 32 from the vehicular exterior side and is elastically deformed gradually so as to move (open) rearward by the guide surface 83 of the stopper projection 81 as illustrated in FIG. 12. When the outer member 51 is moved closer to the trim board 11 and the hole edge of the stopper hole 85 passes the base 84 of the stopper projection 81, the outer end wall 57 of the outer member 51 restores its original shape and the stopper projection 81 is fitted in the stopper hole 85 and the hole edge of the stopper hole 85 is contacted with the stopper surface 84A of the stopper projection 81 as illustrated in FIG. 13. Thus, the stopper projection 81 is stopped by the hole edge of the stopper hole 85. The direction in which the stopper portion 80 is stopped corresponds to the vehicular interior-exterior direction. This restricts movement of the inner member 32 and the outer member 51 in the vehicular-interior-exterior direction. The direction in which the stopper portion 80 is stopped corresponds to the fixing direction in which the fixing portion is fixed to the lower trim 11B. Namely, with the fitting of the stopper projection 81 in the stopper hole 85, the inner member 32 and the outer member 51 are less likely to move with respect to each other in the vehicular interior-exterior direction.

Accordingly, as illustrated in FIG. 3, the overlapping portion 50 including the inner extending portion 37 and the outer extending portion 56 that are overlapped is formed. Then, as illustrated in FIG. 4, the armrest body member 25 is attached to a predetermined position of the lower trim 11B and the pull handle 30 from the vehicular exterior side and the armrest body member 25, the inner member 32, and the outer member 51 are fixed to the lower trim 11B with bolts or nuts or thermal caulking and the fixing portions are formed. As a result, the recess portion 31 of the pull handle 30 with the inner member 32 and the outer member 51 being fixed to the lower trim 11B is obtained.

Next, operations and advantageous effects of this embodiment will be described. The door trim 10 of this embodiment includes the trim board 11 configured as a vehicular inner surface of the vehicular door and the pull handle 30 that includes the recess portion 31 opening upward and is attached to the trim board 11. The pull handle 30 includes the inner member 32 and the outer member 51 that are joined together. The inner member 32 includes the inner wall 33 that is configured as a vehicular interior side wall of the recess portion 31. The outer member 51 includes the outer wall 52 that is configured as a vehicular exterior side wall of the recess portion 31. The inner member 32 and the outer member 51 that are joined together include the overlapping portion 50. The overlapping portion 50 includes the inner extending portion 37 and the outer extending portion 56 that are overlapped with each other. The inner extending portion 37 is a portion of the peripheral edge portion of the inner member 32 and extends outside the recess portion 31. The outer extending portion 56 is a portion of the peripheral edge portion of the outer member 51 and extends outside the recess portion 31.

As illustrated in FIG. 3, the overlapping portion 50 includes the first overlapping portion 50A and the second overlapping portion 50B. The first overlapping portion 50A includes a portion of the flange portion 39 and a portion of the outer rear end extending portion 58 that are overlapped with respect to the vehicular interior-exterior direction. The second overlapping portion 50B includes the inner end wall 38 and the outer end wall 57 that are overlapped with respect to the vehicular front-rear direction, which is the direction along the plate surface of the lower trim 11B. The first overlapping portion 50A overlaps the lower trim 11B of the trim board 11 and is integrally fixed to the lower trim 11B with the fixing portion. The second overlapping portion 50B is closer to the connection portion 30A of the inner member 32 and the outer member 51 than the fixing portion is. The second overlapping portion 50B extends in the direction crossing the plate surface of the lower trim 11B. The second overlapping portion 50B extends in the vehicular interior-exterior direction. The wall surface of the second overlapping portion 50B extends in the direction crossing the plate surface of the lower trim 11B. The pull handle 30 further includes the stopper portion 80 in the second overlapping portion 50B. The stopper portion 80 includes the stopper projection 81 of the inner member 32 and the stopper hole 85 of the outer member 51 and the stopper projection 81 is fitted in the stopper hole 85. With the inner member 32 and the outer member 51 being joined together, the stopper projection 81 and the stopper hole 85 are moved with respect to each other in the fixing direction in which the fixing portion is fixed and thus, the stopper projection 81 and the stopper hole 85 are fitted to each other. Namely, the stopper projection 81 and the stopper hole 85 are relatively moved in the vehicular interior-exterior direction to be fitted to each other.

In this embodiment, the fixing portion (the first overlapping portion 50A) for holding the inner member 32 and the outer member 51 that are fitted together and fixing the inner member 32 and the outer member 51 to the lower trim 11B is away from the connecting portion 30A of the inner member 32 and the outer member 51 because the mounting direction in which the inner member 32 and the outer member 51 are mounted on the lower trim 11B is predetermined. Even in such a configuration, this embodiment includes the stopper portion 80, with which the inner member 32 and the outer member 51 are fitted together, in the second overlapping portion 50B that is close to the connection portion 30A. This increases rigidity of the pull handle 30. Therefore, a gap is less likely to be created at the connection portion 30A between the inner member 32 and the outer member 51 due to deformation of the inner member 32 or the outer member 51 by the force applied toward the vehicular interior side when the pull handle 30 is used.

When the inner member 32 and the outer member 51 are attached to the lower trim 11B, the inner member 32 and the outer member 51 are moved closer to the lower trim 11B along the fixing direction of the fixing portion (the direction in which the mounting bosses project, the vehicular interior-exterior direction) such that the mounting bosses are inserted through the boss insertion holes. With respect to the stopper portion 80, the direction in which the stopper projection 81 is moved relatively to the stopper hole 85 crosses the direction in which the stopper projection 81 projects. The direction in which the stopper projection 81 projects is along the plate surface of the lower trim 11B and differs from the direction in which the mounting bosses 14, 15, 16, 17, 18 project. However, with the configuration of this embodiment, the direction in which the stopper projection 81 is fitted to the stopper hole 85 and the direction in which the mounting bosses 14, 15, 16, 17, 18 are fitted through the boss insertion holes are same. Therefore, the stopper projection 81 can be fitted to the stopper hole 85 when the outer member 51 is attached to the lower trim 11B and the inner member 32. Accordingly, the number of process steps of producing the door trim is not increased to provide the stopper portion 80 and an operation space for fitting the stopper projection 81 in the stopper hole 85 need not be prepared.

As illustrated in FIG. 3, the mounting boss 15, which is the fixing portion, and the stopper portion 80 are arranged on the vehicular rear side of the opening of the recess portion 31 and on the upper edge portion of the inner member 32 and the outer member 51. The mounting boss 15 and the stopper portion 80 are arranged in the vehicular front-rear direction. With such a configuration, the mounting boss 15, which is the fixing portion, and the stopper portion 80 are arranged on the portion where a largest force is applied when the pull handle 30 is used and the effects of the present technology is most likely to be obtained.

The inner wall 33 includes the projection portion 33A that extends along the opening edge 31A of the recess portion 31 and projects toward the vehicular exterior side. The inner wall 33 includes the inner end wall 38 at the rear end of the projection portion 33A. The inner end wall 38 extends toward the vehicular interior side. The stopper projection 81 is on the inner end wall 38 and projects rearward from the inner end wall 38. With the projection portion 33A having such a configuration, the second overlapping portion 50B and the stopper portion 80 can be provided at the end of the projection portion 33A.

The outer member 51 is fixed to the door panel that is disposed on the vehicular exterior side of the lower trim 11B. With such a configuration, since the outer member 51 is fixed to the door panel, the inner member 32 may be more likely to receive a large force and to be deformed if a force directed toward the vehicular interior side is applied to the pull handle 30. However, this embodiment includes the stopper portion 80 having the above configuration and therefore, the gap is less likely to be created between the inner member 32 and the outer member 51 even if a large force is applied to the pull handle 30.

### Other Embodiments

The technology described herein is not limited to the embodiment described above with reference to the drawings. The technical scope of the present disclosure may include the following embodiments and all modifications in the scope of claim or its equivalent scope.
(1) In the above embodiment, the inner member 32 and the outer member 51 are attached to the trim board 11 separately; however, the inner member 32 and the outer member 51 may be joined together first and the inner member 32 and the outer member 51 that are joined together may be attached to the trim board.
(2) In the above embodiment, the pull handle 30 is configured to open toward an upper rear side; however, the pull handle may be included in a horizontally extending armrest and configured to open upward.
(3) In the above embodiment, the stopper portion 80 is on the inner end wall 38 at the rear end of the projection portion 33A; however, the stopper portion may not be on any other portion. The stopper portion and the fixing portion may not necessarily be arranged adjacent to each other.
(4) The outer member may not be fixed to the door panel.

1. A vehicular door trim comprising:
a trim board configured as a vehicular interior surface of a vehicular door; and
a pull handle mounted on the trim board, the pull handle including
a recess portion having an opening that opens upward,
an inner member including an inner body portion and an inner extending portion that extends outside the recess portion from the inner body portion and is configured as a portion of a peripheral edge portion of the inner member, the inner body portion including an inner wall that is configured as a vehicular interior side wall of the recess portion,
an outer member including an outer body portion and an outer extending portion that extends outside the recess portion from the outer body portion and is configured as a portion of a peripheral edge portion of the outer member, the outer body portion including an outer wall that is configured as a vehicular exterior side wall of the recess portion,
the outer member and the inner member being fitted together and configured as the pull handle and defining the recess portion and having a connection portion between the inner member and the outer member, and
an overlapping portion including the inner extending portion and the outer extending portion that are overlapped, the overlapping portion including
a first overlapping portion that overlaps the trim board and is fixed to the trim board with a fixing portion in a fixing direction, and
a second overlapping portion that is adjacent to the connection portion and extends in a direction crossing a plate surface of the trim board, the second overlapping portion including a stopper portion that includes a stopper hole included in one of the inner member and the outer member and a stopper projection included in another one of the inner member and the outer member, and the stopper projection and the stopper hole being fitted to each other by relative movement of the stopper projection and the stopper hole along the fixing direction.

2. The vehicular door trim according to claim 1, wherein the fixing portion and the stopper portion are arranged in a vehicular front-rear direction and are on a vehicular rear side of the opening of the recess portion and on an upper edge portion of the recess portion.

3. The vehicular door trim according to claim 1, wherein
the opening of the recess portion has an opening edge,
the inner wall includes a projection portion at the opening edge and the projection portion projects toward a vehicular exterior side and extends along the opening edge,
the inner member includes an inner end wall at a rear end of the projection portion and the inner end wall extends toward a vehicular interior side and
the stopper projection projects from the inner end wall.

4. The vehicular door trim according to claim 1, wherein the outer member is to be fixed to a door panel that is disposed on the vehicular exterior side of the trim board.

5. The vehicular door trim according to claim 3, wherein
the outer extending portion of the outer member includes an outer end wall that extends toward the vehicular interior side, and
the inner end wall and the outer end wall overlap in a direction along the plate surface of the trim board and configured as the second overlapping portion.

6. The vehicular door trim according to claim 5, wherein
the outer end wall includes the stopper hole,
the inner end wall includes the stopper projection that projects in the direction along the plate surface of the trim board, and
the stopper projection is fitted to the stopper hole with the first overlapping portion being fixed to the trim board in the fixing direction that crosses the plate surface of the trim board.

7. The vehicular door trim according to claim 1, wherein the fixing portion includes a mounting boss projecting from the plate surface of the trim board in the fixing direction and a mounting hole in the first overlapping portion.

8. The vehicular door trim according to claim 1, wherein the first overlapping portion extends along the plate surface of the trim board and includes a portion of the inner extending portion and a portion of the outer extending portion that are overlap in the fixing direction.

9. The vehicular door trim according to claim 1, wherein the stopper hole is included in the outer member and the stopper projection is included in the inner member.

10. A vehicular door trim comprising:
a trim board configured as a vehicular interior surface of a vehicular door; and
a pull handle including
a recess portion having an opening that opens upward and has an opening edge,
an inner member including an inner body portion and an inner extending portion that extends outward from the inner body portion and is configured as a portion of a peripheral edge portion of the inner member, the inner body portion including an inner wall that is configured as a vehicular interior side wall of the recess portion,
an outer member including an outer body portion and an outer extending portion that extends outward from the outer body portion and is configured as a portion of a peripheral edge portion of the outer member, the outer body portion including an outer wall that is configured as a vehicular exterior side wall of the recess portion,
the outer member and the inner member being fitted together in a vehicular interior-exterior direction that crosses a plate surface of the trim board to define the recess portion with upper edge portions of the outer member and the inner member being configured as the opening edge of the recess portion, and the outer member and the inner member having a connection portion between the upper edge portions of the inner member and the outer member; and
an overlapping portion including the inner extending portion and the outer extending portion that are overlapped, the overlapping portion including
a first overlapping portion that overlaps the trim board and extends along the plate surface of the trim board and is fixed to the trim board in the vehicular interior-exterior direction, and
a second overlapping portion that is adjacent to the connection portion and extends along the vehicular interior-exterior direction and includes the inner extending portion and the outer extending portion that are overlapped in a direction along the plate surface of the trim board,
the second overlapping portion including a stopper portion that includes a stopper hole included in the outer extending portion and a stopper projection included in the inner extending portion, and the stopper projection projecting in the direction along the plate surface of the trim board and being fitted to the stopper hole.

11. The vehicular door trim according to claim 10, wherein
the inner member includes an inner end wall at a rear edge of the inner body portion and the inner end wall extends in the vehicular interior-exterior direction, and
the stopper projection projects from the inner end wall.

12. The vehicular door trim according to claim 11, wherein
the outer extending portion of the outer member includes an outer end wall that extends in the vehicular interior-exterior direction, and
the inner end wall and the outer end wall overlap in the direction along the plate surface of the trim board and configured as the second overlapping portion.

13. The vehicular door trim according to claim 12, wherein
the outer end wall includes the stopper hole,
the inner end wall includes the stopper projection that projects in the direction along the plate surface of the trim board, and
the stopper projection is fitted to the stopper hole with the first overlapping portion being fixed to the trim board in the vehicular interior-exterior direction.
